(19) United States
(12) Patent Application Publication
(10) Pub. No.: US 2012/0219797 A1
(43) Pub. Date: Aug. 30, 2012

(54) Semiconductor Powder and Method for Producing the Same

(75) Inventors: Tetsuya Mitsumoto, Takehara-shi (JP); Yuichi Anno, Ageo-shi (JP)

(73) Assignee: MITSUI MINING & SMELTING CO., LTD., Shinagawa-Ku (JP)

(21) Appl. No.: 13/388,857

(22) PCT Filed: Jun. 3, 2010
(86) PCT No.: PCT/JP2010/059438

§ 371 Date: Apr. 16, 2012

(30) Foreign Application Priority Data
Aug. 6, 2009 (JP) 2009183412

(51) Int. Cl. H01B 1/10; B32B 5/16; C01G 19/00

(52) U.S. Cl. 428/402; 252/519.14; 423/511

(57) ABSTRACT

The present invention provides a semiconductor powder composed of Cu-M-Sn—S in a single phase wherein M is at least one selected from the group consisting of Zn, Co, Ni, Fe and Mn, the powder being obtained by wet synthesis, and a method for producing this semiconductor powder. According to the present invention, it is possible to provide, in a simple way, a high-grade semiconductor powder composed of a single-phase Cu-M-Sn—S such as CZTS.

### CROSS-REFERENCE TO RELATED APPLICATION

This application claims priority to Japanese Patent Application No. 2009-183412 filed on Aug. 6, 2009, the entire disclosure of which is incorporated herein by reference.

### TECHNICAL FIELD

The present invention relates to a semiconductor powder having a composition of Cu-M-Sn—S wherein M is at least one selected from the group consisting of Zn, Co, Ni, Fe and Mn and a method for producing this semiconductor powder.

### BACKGROUND ART

In recent years, there has been an increasing expectation for Cu₂ZnSnS₄ (CZTS) as a next-generation semiconductor. This CZTS is known as having benefits such that abundant amounts of the constituent elements exist on the earth, that CZTS has a bandgap energy (1.4 to 1.5 eV) suitable for solar cells, and that CZTS includes no environmentally burdening elements or rare elements. For example, CZTS in a thin film form has been proposed in solar cell applications (Patent Literatures 1 and 2).

In addition, not only Cu₂ZnSnS₄ (CZTS) but also CZTS-like compounds such as Cu₂CoSnS₄, Cu₂NiSnS₄, Cu₂FeSnS₄ and Cu₂MnSnS₄ are academically prepared and analyzed (Non-Patent Literature 1). However, these compounds are merely those obtained as a single crystal, and are not suitable for industrial utilization not only because a long time is required for forming a single crystal but also because a coarse single crystal needs to be elaborately pulverized and processed to form a powder having desired particle diameters for industrial utilization. It is thus desirable that a high-grade CZTS and its similar compounds in powder form can be produced in a simple way.

### CITATION LIST

### Patent Literature

Patent Literature 1: JP2007-269589A

Patent Literature 2: JP2009-26891A

### Non-Patent Literature

Non-Patent Literature 1: Mat. Res. Bull. Vol. 9, pp.645-654, 1974

### SUMMARY OF THE INVENTION

The inventors have currently found that it is possible to produce, in a simple way according to wet synthesis, a high-grade semiconductor powder composed of a single-phase Cu-M-Sn—S such as CZTS, wherein M is at least one selected from the group consisting of Zn, Co, Ni, Fe and Mn.

It is thus an object of the present invention to provide, in a simple way, a high-grade semiconductor powder composed of a single-phase Cu-M-Sn—S such as CZTS, wherein M is at least one selected from the group consisting of Zn, Co, Ni, Fe and Mn.

According to an aspect of the present invention, there is provided a semiconductor powder composed of Cu-M-Sn—S in a single phase wherein M is at least one selected from the group consisting of Zn, Co, Ni, Fe and Mn, the powder being obtained by wet synthesis.

According to another aspect of the present invention, there is provided a method for producing a semiconductor powder composed of Cu-M-Sn—S in a single phase, wherein M is at least one selected from the group consisting of Zn, Co, Ni, Fe and Mn, the method comprising the steps of:

providing an aqueous solution of a sulfide selected from the group consisting of ammonium sulfide, ammonium polysulfide, sodium sulfide, thiourea and thioacetamide;

adding Cu, M and Sn and an inorganic acid into the aqueous solution separately or simultaneously, wherein the Cu, M and Sn are in the form of inorganic acid salt or aqueous solution thereof, to provide a mixture liquid having a pH of 4 to 9;

agitating the mixture liquid to form a precipitate;

filtrating the precipitate through solid-liquid separation;

calcinating the filtrated precipitate under inert gas atmosphere or under coexistence of a sulfur-containing compound except for sulfur oxides, to obtain the semiconductor powder.

According to another aspect of the present invention, there is provided a dispersion liquid comprising precursor particles for a semiconductor powder dispersed in a solvent, wherein the semiconductor particles are composed of Cu-M-Sn—S, wherein M is at least one selected from the group consisting of Zn, Co, Ni, Fe and Mn, and wherein the precursor particles are obtained by wet synthesis.

According to another aspect of the present invention, there is provided a semiconductor product which is produced by using the semiconductor powder or the dispersion liquid, wherein the semiconductor product is selected from the group consisting of pellets for vapor deposition, sputtering targets and semiconductor thin films.

### BRIEF DESCRIPTION OF THE DRAWINGS

FIG. 1 is an XRD chart of a CZTS powder produced in Example 1.

FIG. 2 shows particle size distribution data of the powder produced in Example 1.

FIG. 3 shows particle size distribution data of a CZTS powder recovered with a bag filter after a jet mill pulverization, in accordance with Example 2.

FIG. 4 shows particle size distribution data of a CZTS powder recovered with a cyclone separator after a jet mill pulverization, in accordance with Example 2.

FIG. 5 shows particle size distribution data of a CZTS powder passed through a sieve with apertures of 75 μm while being crumbled, in accordance with Example 2.

FIG. 6 is an XRD chart of CZTS powders produced in Example 3.

FIG. 7 is an enlarged chart showing the circled portions in FIG. 6.

FIG. 8 is an XRD chart of CZTS powders produced in Example 4.

FIG. 9 is an XRD chart of CZTS powders produced in Examples 5 and 6.

FIG. 10 is an enlarged chart showing the circled portions in FIG. 9.

FIG. 11 is an XRD chart of CZTS powders produced in Examples 7 to 11.

FIG. 12 is an XRD chart of a CZTS powder produced in Example 12.

FIG. 13 is an XRD chart of CZTS powders produced in Example 13.

FIG. 14 is an XRD chart of CZTS powders produced in Example 14.

FIG. 15 is an XRD chart of CZTS powders produced in Example 15.

FIG. 16 is an enlarged chart showing the circled portions in FIG. 15.

FIG. 17 is an XRD chart of a Cu₂CoSnS₄ powder produced in Example 16.

FIG. 18 is an XRD chart of a Cu₂FeSnS₄ powder produced in Example 17.

FIG. 19 is an XRD chart of a Cu₂MnSnS₄ powder produced in Example 18.

### DESCRIPTION OF THE EMBODIMENTS

Semiconductor Powder

The semiconductor powder according to the present invention is composed of a single phase Cu-M-Sn—S, wherein M is at least one selected from Zn, Co, Ni, Fe and Mn, preferably having a composition of Cu₂MSnSₓ, wherein x is 3.5 to 4.5, desirably 4.0, more preferably a composition of Cu₂ZnSnS₄ (CZTS). A semiconductor having the above composition is advantageous in that (1) abundant existence of the constituent elements brings no anxiety about supply shortage, (2) the toxicity is low, leading to environmental friendliness, (3) a wide light absorption region and a high light absorption coefficient make it possible to absorb light sufficiently even in a thin film form, (4) this semiconductor mainly has p-type semiconductor properties, which are considered to be convertible to n-type properties and vice versa, and (5) the bandgap resides in 1.4 to 1.5 eV which enables band engineering. In particular, since the advantages (4) and (5) are considered to be achievable by varying the constituent elements or the constituent ratio of the powder, wet synthesis employed in the present invention is very advantageous in that the constituent elements or the constituent ratio can be easily varied. In view of the above advantages (1) to (5), a thin film made of the semiconductor powder of the present invention is expected to be applied as a light absorption layer of a solar cell.

The semiconductor powder according to the present invention is obtained by wet synthesis. According to the findings by the inventors, a high-grade single phase Cu-M-Sn—S semiconductor in powder form can be directly synthesized in a simple way. Although single crystal growth cannot be suitable for industrial use due to not only a long time required for the growth but also the necessity to elaborately pulverize a coarse single crystal to a powder having desired particle diameters for industrial use, the wet synthesis makes it possible to directly synthesize a powder for a relatively short time, being preferable for industrial use.

Identification of the semiconductor powder of the present invention obtained by wet synthesis can be conducted by performing XRD analysis on the powder with an X-ray powder diffractometer (XRD) and comparing the result with a single crystal chart in a JCPDS card of the corresponding composition. The semiconductor powder can be confirmed to be a single phase by confirming that the XRD chart obtained by the XRD analysis does not contain unidentified peaks attributed to by-products other than peaks shown in the JCPDS card. It is also possible to presume the degree of crystallinity on the basis of the heights of the peak intensities, for which overall higher peak intensities mean a higher crystallinity. In the meantime, according to the findings by the inventors, there appears a tendency that the height ratio of the second peak (the second highest peak) to the main peak (the highest peak) in the XRD chart measured on the semiconductor powder obtained by wet synthesis is lower than the height ratio of the second peak to the main peak in the corresponding JCPDS card. It is thus considered to be possible to presume, on the basis of this tendency, whether or not a given semiconductor powder has been obtained by wet synthesis.

According to a preferred embodiment of the present invention, each particle constituting the semiconductor powder has a particle size in the range of 0.10 to 1000 μm, typically 0.20 to 850 μm. The particle size referred to herein means a diameter of each particle that is measured by a particle size distribution measuring apparatus, and does not mean an average particle size. Therefore, the semiconductor powder may comprise constituent particles having a wide variety of diameters from small to large within the above range. Preferred particle size range may be determined depending on usage and application of the semiconductor powder. For example, when a slurry comprising the semiconductor powder is applied to form a semiconductor film, the range of from 0.1 to 1 μm is preferred. When the semiconductor powder is molded into a target by pressurization or the like, the range of from 0.1 to 10 μm is preferred. Although the semiconductor powder of the present invention is obtained in powder form by wet synthesis, the particle size may be controlled by appropriately pulverizing the powder with a jet mill, a ball mill or the like so as to provide desired particle sizes or by recovering the pulverized powder with a bag filter, a cyclone separator or the like.

Production Method

In the method for producing the semiconductor powder according to the present invention, an aqueous solution of at least one sulfide selected from ammonium sulfide, ammonium polysulfide, sodium sulfide, thiourea and thioacetamide is first prepared. This sulfide aqueous solution acts as a sulfur source for the semiconductor powder. The ammonium sulfide aqueous solution is not particularly limited but may be a commercially available sulfur ammonium reagent with a concentration of 1, 10, 20 or 40% by mass or the like. The pH of the ammonium sulfide aqueous solution is also not particularly limited but may be, for example, pH 11.1 to 11.4 for the concentration of 1 by mass and pH 10.0 to 10.5 for the concentration of 40% by mass, which are shown for reference. Ammonium polysulfide ((NH₄)₂Sₓ) can be used in the same manner as ammonium sulfide. Sodium sulfide is available in solid form, and may be used by appropriately adjusting the concentration, which may be in the same concentration range as that of ammonium sulfide.

According to a preferred embodiment of the present invention, the amount of the sulfide aqueous solution is chosen so as to supply sulfur in a sulfur proportion higher than that of the stoichiometric composition of a semiconductor powder to be obtained. For example, when the composition of a semiconductor powder to be obtained is Cu₂MSnS₄, the Cu:M:Sn:S ratio in the preparatory liquid of 2:1:1:(more than 4), preferably 2:1:1: (5 or more), more preferably 2:1:1:(5 to 10), makes it possible to stably obtain a desired semiconductor powder.

To the above sulfide aqueous solution, an inorganic acid and Cu, M and Sn in the form of inorganic acid salt or aqueous solution are added separately or simultaneously to provide a mixture liquid having a pH of 4 to 9. Examples of the inorganic acid salts include, but not limited to, sulfates, nitrates, acetates, chlorides and combinations thereof, preferably sulfates, nitrates, acetates and combinations thereof, more preferably sulfates. Examples of the inorganic acid include, but not limited to, sulfuric acid, nitric acid, acetic acid, hydrochloric acid and combinations thereof, preferably sulfuric acid, nitric acid, acetic acid and combinations thereof, more preferably sulfuric acid. For example, in the case where the inorganic acid salts and the inorganic acid are sulfates and sulfuric acid respectively, these ingredients are preferred to be added in the order of Sn (tin sulfate), Zn (zinc sulfate), Cu (copper sulfate), and sulfuric acid, of which the order is referentially applicable to the case other than the combination of sulfates and sulfuric acid, as well as to the case where the Zn is partially or entirely replaced by at least one of Co, Ni, Fe and Mn. The addition of each salt is preferred to be done in aqueous solution form, in which the amount of water used to prepare the aqueous solution may be the minimum amount required for dissolving the salt in reference to the solubility. That is, it is considered that there is no negative effect caused by the amount of water, and indeed a sample of a single phase can be obtained even when the salt is dissolved with water in an amount ten times as large as the minimum amount. The above inorganic acid salts of Cu, M and Sn can be added simultaneously, and in this case, a liquid in which three types of salts of Cu, M and Sn are dissolved may be prepared and added to an ammonium sulfide aqueous solution. The addition of the inorganic acid is preferred to be done after adding inorganic acid salts, in that the pH of the mixture liquid can be easily adjusted.

Although the pH of the liquid before the addition of the inorganic acid varies depending on the type of the sulfur source or the inorganic salt to be used, the inorganic acid may be added to bring the mixture liquid to pH 4 to 9, preferably pH 5 to 8, more preferably pH 6.5 to 7.5. There is a tendency that elution of zinc is observed at the acid side while elution of zinc and tin is observed at the alkaline side. At any rate, within the above pH range, all eluted substances can precipitate as precursors without eluting cations, while a single-phase semiconductor powder can be obtained after calcination.

Subsequently, the above mixture liquid is stirred to form precipitates, and then subjected to solid-liquid separation to recover the precipitates by filtration. The solid-liquid separation may be performed in various known techniques, such as natural filtration, suction filtration and centrifugation, although not particularly limited thereto. However, since centrifugation may cause elution of copper, zinc and tin in supernatant, natural filtration and suction filtration are preferred as raising no such concern. The obtained precipitates may be further subjected to repulp washing, in which the amount of water to be used is not particularly limited as having no effect considered on the sample. It is, however, possible to obtain a single-phase semiconductor powder without repulp washing.

Finally, the filtered precipitates are subjected to calcination under inert gas atmosphere or under coexistence with a sulfur-containing compound other than sulfur oxides to obtain the semiconductor power of the present invention. That is, calcination may be carried out under inert gas atmosphere such as nitrogen and argon, or under coexistence with a sulfur-containing compound such as hydrogen sulfide and sulfurous vapor. Although the use of the sulfur-containing compound can sulfurize the film, the sulfur oxide SO_{X} is exempted from the usable sulfur-containing compounds of the present invention since the sulfur oxide adversely affects the film by its oxidizing ability. It is a matter of course that the sulfur-containing compound may be in gas form, while even the compound in solid or liquid form can be used under coexistence with the precipitates. For example, the film can be sulfurized by calcining the precipitates together with a sulfuric powder. Preferred sulfur-containing compounds include hydrogen sulfide, sulfur (vapor), sulfur (powder), carbon bisulfide, and organic sulfur compounds.

The calcination temperature is not particularly limited since it varies depending on the composition of the powder and the atmosphere. For example, the temperature of calcination under inert gas atmosphere such as nitrogen atmosphere is preferred to be 300 to 800° C. for ease in forming a single phase, more preferably 300 to 600° C., still more preferably 400 to 500° C. Excessively high calcination temperature is not preferred as expelling sulfur to cause sulfur shortage. However, the temperature of calcination under hydrogen sulfide atmosphere may be 300 to 1000° C. since calcination at a high temperature is possible by virtue of adopting the atmosphere supplied with sulfur, which is otherwise insufficient.

According to a preferred embodiment of the present invention, prior to calcination, the filtered precipitates may be dried under inert gas atmosphere or under coexistence with a sulfur-containing compound other than sulfur oxides. Air drying is not preferred due to formation of tin oxide as a by-product.

Dispersion Liquid

The dispersion liquid obtained as the mixture liquid in the above production method, which includes precursor particles of the semiconductor powder dispersed in a solvent, can be used by itself as a coating liquid for thin-film formation. That is, a semiconductor thin film can be easily formed by applying this dispersion liquid to a substrate and calcining it. Alternatively, it is possible to easily obtain the semiconductor powder only by subjecting the dispersion liquid to solid-liquid separation and calcining the resulting filtered precipitates. The particle diameters of the precursor particles in the dispersion liquid are not particularly limited but preferably 0.10 to 3.0 μm, more preferably 0.10 to 1.0 μm.

Applications

The semiconductor powder and dispersion liquid of the present invention is suitable for thin-film formation, and thus can be used preferably in various applications such as a light absorption layer of a solar cell. While the techniques for forming the thin film is not particularly limited, the thin film may be easily formed according to various known techniques, such as a vapor deposition by heating a pellet of the semiconductor powder, a sputtering using a sintered body target of the semiconductor powder, a spin coating by applying a dispersion liquid of the semiconductor powder to a rotating substrate, or a dip coating by immersing a substrate in a dispersion liquid of the semiconductor powder. Therefore, preferred forms of products prepared by using the semiconductor powder and dispersion liquid of the present invention include pellets for vapor deposition, sputtering targets, and semiconductor thin films. As a dispersion liquid to be used for spin coating or dip coating, it is possible to use, as it is, a dispersion liquid in which the end-product semiconductor powder is dispersed in a solvent, as well as a dispersion liquid in which the above precursor particles for the semiconductor powder are dispersed in a solvent.

In particular, the semiconductor powder provided by wet synthesis according to the present invention contains a relatively large amount of sulfur, and thus has an advantage that it is possible, at the stage before annealing, to have the thin film already contain sulfur in an amount equal to or close to the stoichiometric composition. In contrast, under the conventional thin-film forming techniques for similar compositions, such thin films, which are supposed to be finally sulfurated with hydrogen sulfate or by sulfur annealing, predominantly use metals as raw materials rather than sulfides. This is considered to lead to a great sulfur shortage at the stage before annealing.

### EXAMPLES

The present invention will be further described with reference to the following examples.

### Example 1

### Preparation of CZTS Semiconductor Powder

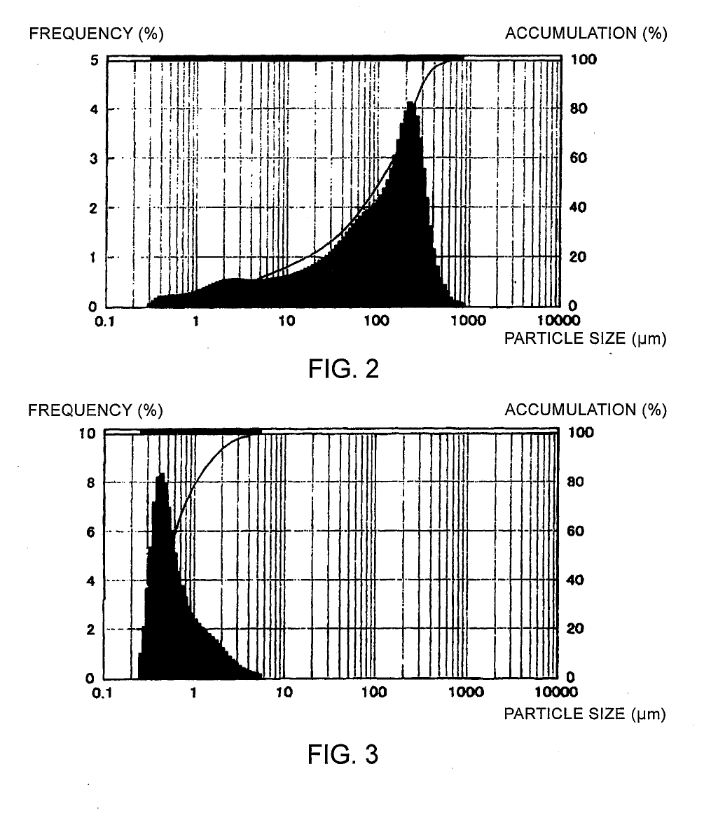

22 ml of tin sulfate aqueous solution of pH 1.1 containing 5.06 g of tin sulfate dissolved therein was added to 40 ml of 20 mass % ammonium sulfide aqueous solution of pH 10.0, and was then stirred for 15 minutes to obtain a mixture liquid of pH 9.8. Subsequently, 14 ml of zinc sulfate aqueous solution of pH 4.5 containing 6.77 g of zinc sulfate heptahydrate dissolved therein was added to the mixture liquid, and was then stirred for 15 minutes to obtain a mixture liquid having a pH of 9.6. Further, to this mixture liquid, 80 ml of copper sulfate aqueous solution of pH 3.5 containing 11.76 g of copper sulfate pentahydrate dissolved therein was added to obtain a mixture liquid of pH 9.3. The mixture liquid thus obtained was subjected to neutralization by adding 2.8 ml of concentrated sulfuric acid, to obtain a preparatory liquid of pH 7.5. The Cu:Zn:Sn:S ratio in the preparatory liquid was about 2:1:1:5. The mixture liquid was stirred for 1 hour with this pH being retained, followed by natural filtration. The filtration residue was subjected to repulp washing with 750 ml of water, followed by natural filtration again. The precipitates thus obtained were subjected to calcination (powder annealing) by retaining the precipitates for 2 hours under nitrogen atmosphere at 500° C. to obtain a Cu₂ZnSnS₄ (CZTS) semiconductor powder, without undergoing drying process. The particle size distribution of the obtained powder was measured by laser diffraction/scattering particle size distribution measurement device (Microtrac MT3200 (WET), Nikkiso Co., Ltd.). Measurement conditions were set so that the permeation condition was particle permeability and that the particle refractive index was 1.81. The measured data are shown in FIG. 2.

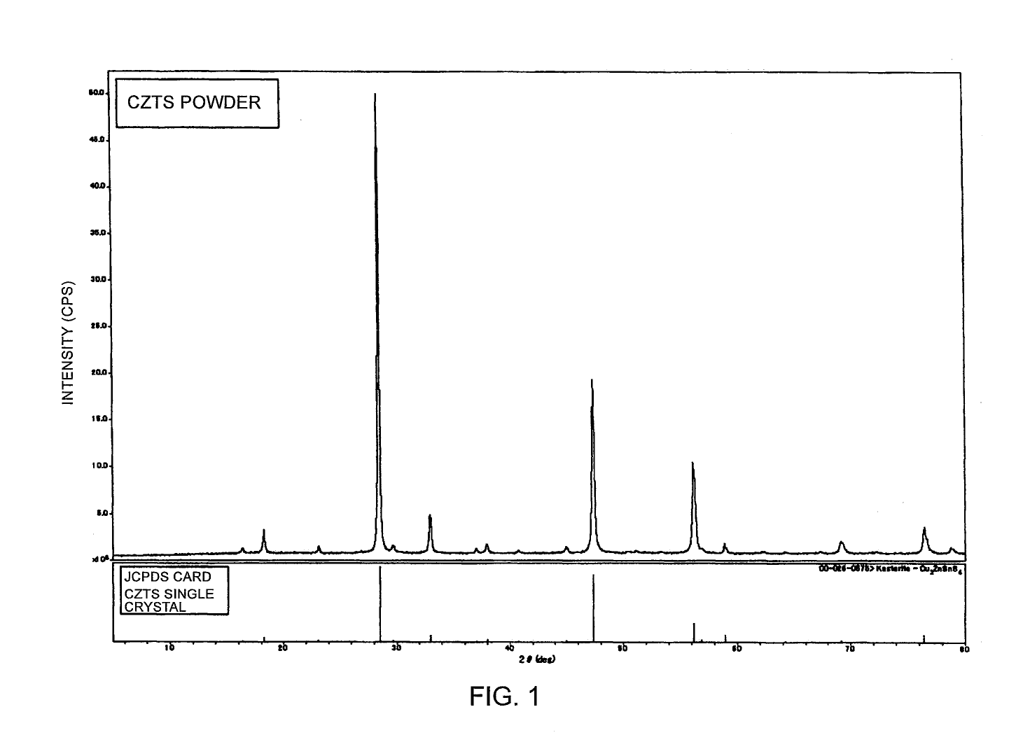

This semiconductor powder was subjected to XRD analysis by an X-ray powder diffractometer (XRD) (RINT-TTR III, Rigaku Corporation) to obtain an XRD chart shown in FIG. 1. By comparing the obtained XRD chart with the CZTS single crystal chart in the JCPDS card, which is also shown in FIG. 1, it was confirmed that the positions of the peaks in the both charts are identical to each other with no unidentified peak, meaning that the obtained semiconductor powder was a single-phase Cu₂ZnSnS₄ (CZTS) semiconductor powder. The peak intensity of the CZTS powder in the vicinity of 47° ((200) plane) was lower than that of the single crystal. This is considered to be due to the relatively strong peak in the vicinity of 28° ((112) plane) leading to the orientation to (112) plane. While the height ratio of the second peak (the second highest peak) to the main peak (the highest peak) in the JCPDS card was calculated to be 0.9 (=90/100), the height ratio of the second peak to the main peak in the XRD chart obtained in this Example was calculated to be 0.50. It is therefore recognized that the height ratio of the second peak to the main peak of the Cu₂ZnSnS₄ (CZTS) single-crystal powder obtained by wet synthesis tends to be lower than that in the JCPDS card. The obtained powder was processed into a pellet with a diameter of 10 mm and a thickness of 2 mm, and Was then provided with a temperature difference of 12.8° C. between the upper surface and lower surface (the higher temperature part: 31.2° C., the lower temperature part: 18.4° C.) for the measurement of the electromotive force between the upper surface and lower surface. The electromotive force thus measured was 2154 μV, based on which the Seebeck coefficient was calculated to be 168.3 μV/° C. (=2154/12.8). Since the value was a positive value, it was confirmed that the CZTS semiconductor powder obtained in this Example was a p-type semiconductor.

### Example 2

### Particle-Size Control of CZTS Semiconductor Powder

The CZTS semiconductor powder obtained in Example 1 was subjected to either one of the following steps to control the particle size, followed by the measurement of the particle size distribution using a laser diffraction/scattering particle size distribution measurement device (Microtrac MT3200 (WET), Nikkiso Co., Ltd.):

Step 1: the powder was pulverized by a jet mill (KJ-25, Kurimoto, Ltd.) under the conditions of a classification rotor frequency of 300 Hz and a pulverization pressure of 0.5 MPa, and then recovered by a bag filter;

Step 2: the powder was pulverized by a jet mill (KJ-25, Kurimoto, Ltd.) under the conditions of a classification rotor frequency of 300 Hz and a pulverization pressure of 0.5 MPa, and then recovered by a cyclone separator; or

Step 3: the powder was passed through a sieve with apertures of 75 μm while being crumbled in a mortar.

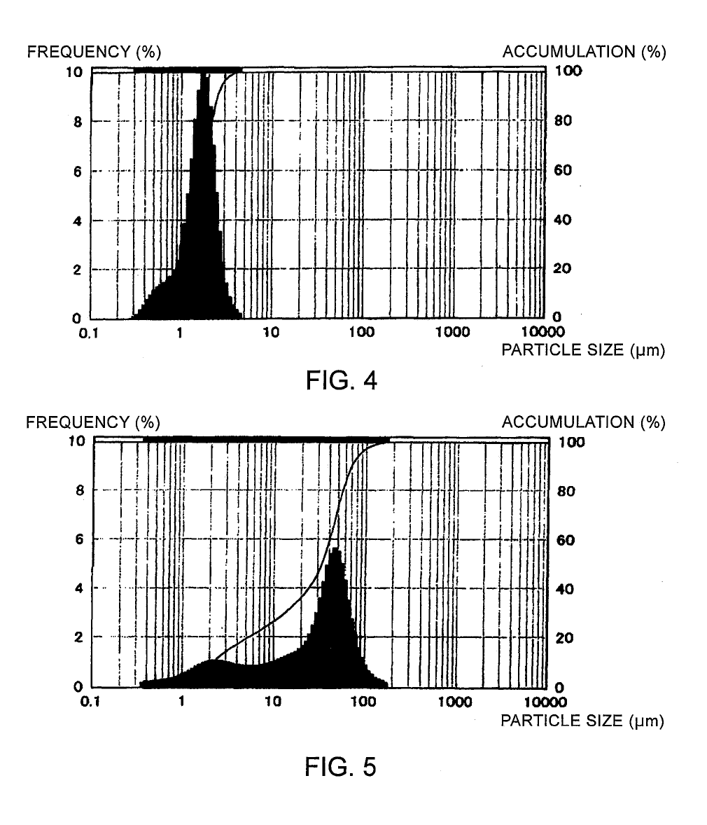

The particle size distribution data obtained for the steps 1, 2 and 3 are shown in FIGS. 3, 4 and 5, respectively. As can be seen from the results of FIGS. 2 to 5, the particle size distribution can become either sharp or broad depending on the pulverization technique.

### Example 3

### Preparation of CZTS Semiconductor Powder Having Various Cu:Zn:Sn:S Ratios

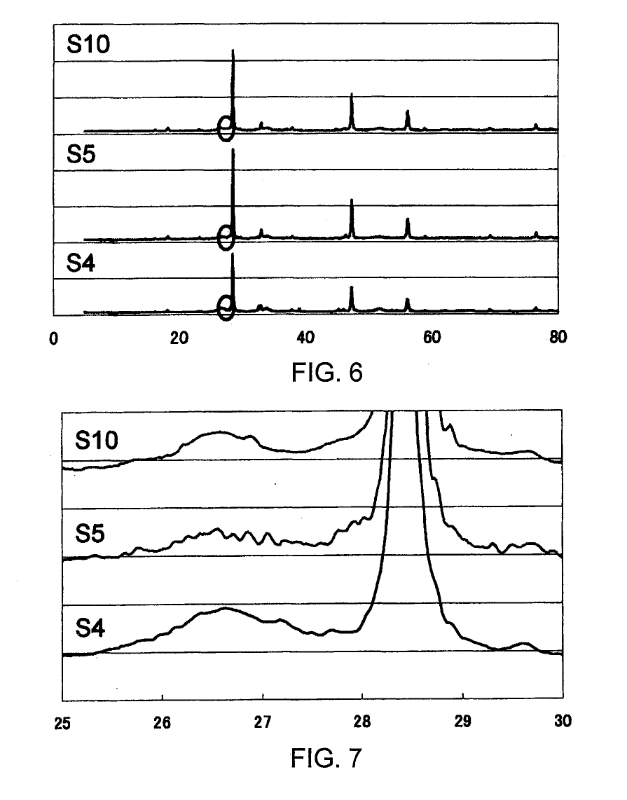

Preparation of each Cu₂ZnSnS₄ (CZTS) semiconductor powder and XRD analysis were conducted in the same manner as in Example 1 to obtain XRD charts shown in FIGS. 6 and 7, except that each additive amount of the raw materials was adequately changed so that the Cu:Zn:Sn:S ratio in the preparatory liquid could be about 2:1:1:4 and about 2:1:1:10 respectively. FIG. 7 is an enlarged chart showing the circled portions in FIG. 6. FIGS. 6 and 7 also show, for reference, the XRD chart obtained on the sample of the Cu:Zn:Sn:S ratio of about 2:1:1:5 obtained in Example 1. As apparent from FIGS. 6 and 7, the sample resulting from the preparatory liquid having the Cu:Zn:Sn:S ratio of about 2:1:1:5 exhibited roughly the same peak behavior over the entire diffraction angles as the sample of the Cu:Zn:Sn:S ratio of about 2:1:1:5 in Example 1. In contrast, the sample resulting from the preparatory liquid having the Cu:Zn:Sn:S ratio of about 2:1:1:4 exhibited, in the diffraction angle range of 25 to 28°, a peak behavior that was slightly different from that of the sample of the Cu:Zn:Sn:S ratio of about 2:1:1:5 of Example 1, which would have been caused by the formation of a by-product. As seen from these results, a single-phase Cu₂ZnSnS₄ (CZTS) semiconductor powder can be stably obtained, by using a preparatory liquid having the Cu:Zn:Sn:S ratio of about 2:1:1:(5 or more), which contains sulfur in an excessive amount in terms of the stoichiometric proportion of Cu₂ZnSnS₄.

### Example 4

### Preparation of CZTS Semiconductor Powders Using Different Kinds of Ammonium Sulfides

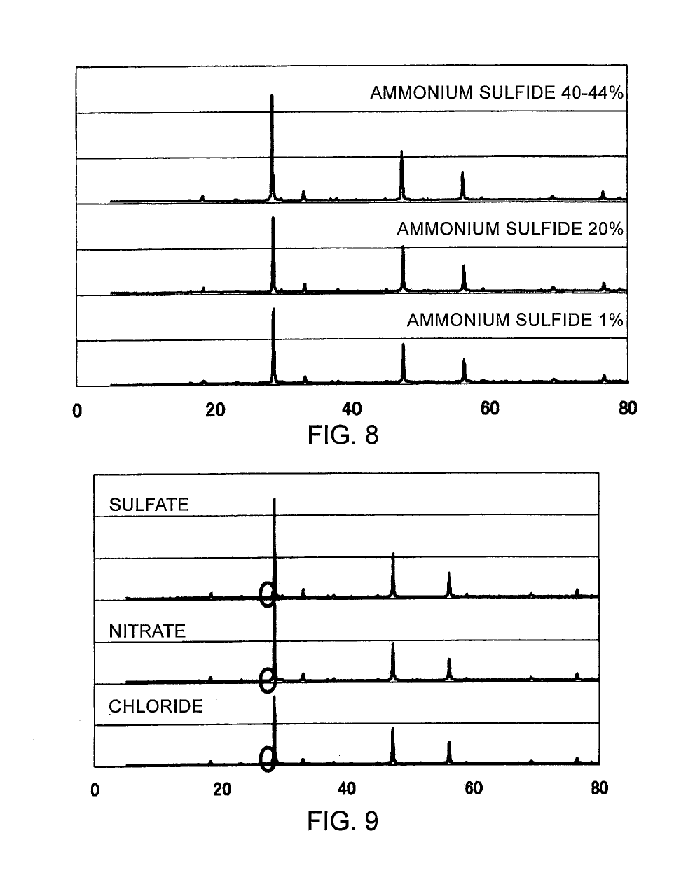

Preparation of each Cu₂ZnSnS₄ (CZTS) semiconductor powder and XRD analysis were conducted in the same manner as in Example 1 to obtain XRD charts shown in FIG. 8, except that 1 mass % ammonium sulfide aqueous solution (colorless and transparent), 10 mass % ammonium sulfide aqueous solution (yellow color), or 40 to 44 mass % ammonium sulfide aqueous solution was used, instead of using 20 mass % ammonium sulfide aqueous solution, to add an ammonium sulfide aqueous solution in such an amount that the additive amount of ammonium sulfide was identical to that of Example 1 in terms of sulfur. As apparent from FIG. 8, a single-phase Cu₂ZnSnS₄ (CZTS) semiconductor powder can be obtained regardless of the concentration or color of an ammonium sulfide aqueous solution to be used.

### Example 5

### Preparation of CZTS Semiconductor Powder Using Different Raw Materials (1)

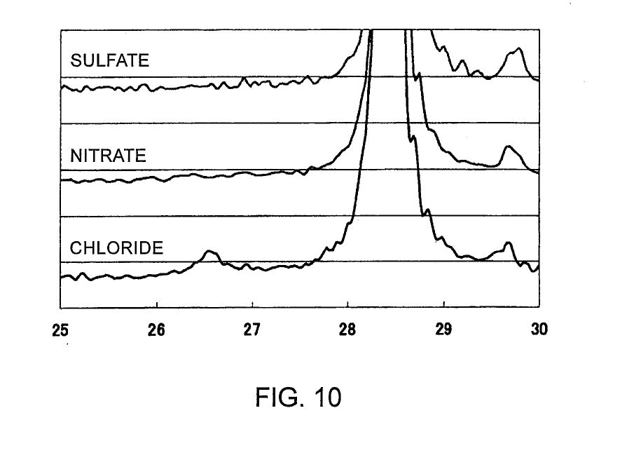

Preparation of each Cu₂ZnSnS₄ (CZTS) semiconductor powder and XRD analysis were conducted in the same manner as in Example 1 to obtain XRD charts shown in FIGS. 9 and 10, except that chloride raw materials (tin chloride, zinc chloride, copper chloride and hydrochloric acid) were added instead of the sulfuric-acid-based raw materials (tin sulfate, zinc sulfate heptahydrate, copper sulfate pentahydrate, and concentrated sulfuric acid), so that the additive amounts could be identical to those in Example 1 in terms of each element of Sn, Zn and Cu and that the pH of the preparatory liquid could be equal to that in Example 1 (pH7.5). FIG. 10 is an enlarged chart showing the circled portions in FIG. 9. FIGS. 9 and 10 also show, for reference, XRD charts obtained with use of the sulfuric-acid-based raw materials in Example 1. As apparent from FIG. 9, a seemingly similar peak behavior was observed over the entire diffraction angles regardless of the type of the raw-materials. However, in the enlarged chart in FIG. 10, a peak seemingly due to a by-product tin oxide was observed around a diffraction angle of 26.5 degrees on the sample prepared from the chloride raw-materials. As seen from these results, using sulfuric-acid-based raw-materials makes it easier to obtain a single-phase Cu₂ZnSnS₄ (CZTS) semiconductor powder of higher grade than using chloride raw materials.

### Example 6

### Preparation of CZTS Semiconductor Powder Using Different Raw-Materials (2)

Preparation of each Cu₂ZnSnS₄ (CZTS) semiconductor powder and XRD analysis were conducted in the same manner as in Example 1 to obtain XRD charts shown in FIGS. 9 and 10, except that nitric-acid-based raw materials (zinc nitrate, copper nitrate and nitric acid, and tin sulfate instead of tin nitrate due to its unavailability) were added instead of the sulfuric-acid-based raw materials (tin sulfate, zinc sulfate heptahydrate, copper sulfate pentahydrate, and concentrated sulfuric acid), so that the additive amounts could be identical to those in Example 1 in terms of each element of Sn, Zn and Cu and that the pH of the preparatory liquid could be equal to that in Example 1 (pH7.5). FIG. 10 is an enlarged chart showing the circled portions in FIG. 9. FIGS. 9 and 10 also show, for reference, XRD charts obtained with use of the sulfuric-acid-based raw materials in Example 1. As apparent from FIGS. 9 and 10, the sample prepared from the nitric-acid-based raw materials also exhibited a peak behavior similar to that from the sulfuric-acid-based raw materials over the entire diffraction angles. As seen from these results, using nitric-acid-based raw materials also makes it possible to provide a single-phase Cu₂ZnSnS₄ (CZTS) semiconductor powder of high grade as in the case of using sulfuric-acid-based raw materials.

### Example 7

### Preparation of CZTS Semiconductor Powder Using Different Raw-Materials (3)

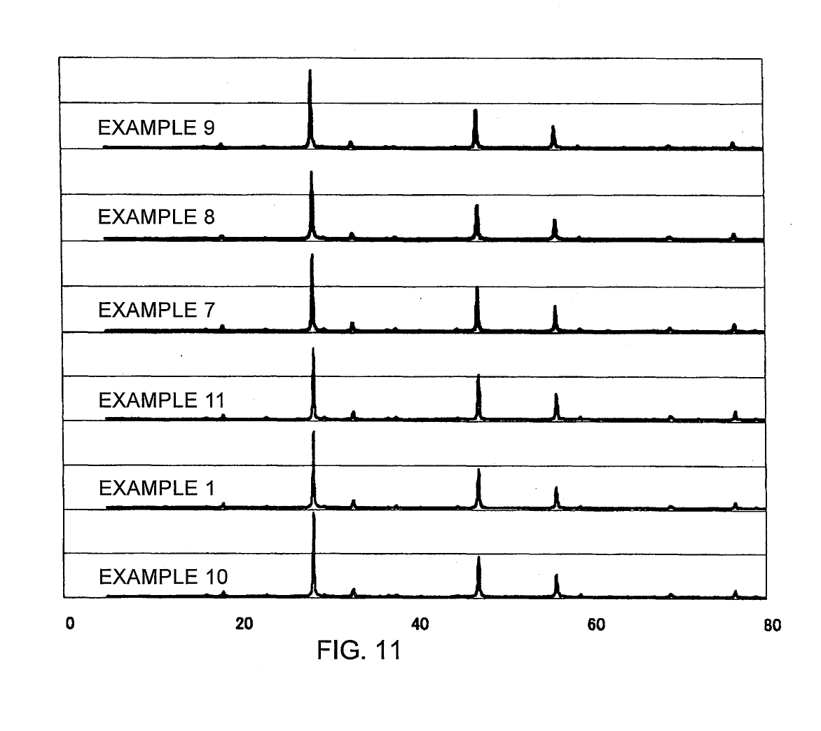

Preparation of Cu₂ZnSnS₄ (CZTS) semiconductor powder and XRD analysis were conducted in the same manner as in Example 1 to obtain an XRD chart shown in FIG. 11, except that tin chloride (tetravalent) instead of tin sulfate, zinc nitrate instead of zinc sulfate heptahydrate, copper nitrate instead of copper sulfate pentahydrate, and nitric acid instead of sulfuric acid were added so that the additive amounts could be identical to those in Example 1 in terms of each element of Sn, Zn and Cu and that the pH of the preparatory liquid could be equal to that in Example 1 (pH7.5). FIG. 11 also shows, for reference, the XRD chart obtained in Example 1. As apparent from FIG. 11, even when the raw-materials were replaced as mentioned above, peaks were observed at the same positions as in the sample obtained in Example 1, indicating that a single-phase Cu₂ZnSnS₄ (CZTS) semiconductor powder was obtained as in Example 1.

### Example 8

### Preparation of CZTS Semiconductor Powder Using Different Raw-Materials (4)

Preparation of Cu₂ZnSnS₄ (CZTS) semiconductor powder and XRD analysis were conducted in the same manner as in Example 1 to obtain an XRD chart shown in FIG. 11, except that tin chloride (tetravalent) instead of tin sulfate as well as nitric acid instead of sulfuric acid were added so that the additive amounts could be identical to those in Example 1 in terms of each element of Sn and Zn and that the pH of the preparatory liquid could be equal to that in Example 1 (pH7.5). FIG. 11 also shows, for reference, the XRD chart obtained in Example 1. As apparent from FIG. 11, even when the raw-materials were replaced as mentioned above, peaks were observed at the same positions as in the sample obtained in Example 1, indicating that a single-phase Cu₂ZnSnS₄ (CZTS) semiconductor powder was obtained as in Example 1.

### Example 9

### Preparation of CZTS Semiconductor Powder Using Different Raw-Materials (5)

Preparation of Cu₂ZnSnS₄ (CZTS) semiconductor powder and XRD analysis were conducted in the same manner as in Example 1 to obtain an XRD chart shown in FIG. 11, except that tin chloride (tetravalent) instead of tin sulfate was added so that the additive amount could be identical to that in Example 1 in terms of Sn. FIG. 11 also shows, for reference, the XRD chart obtained in Example 1. As apparent from FIG. 11, even when the raw-material was replaced as mentioned above, peaks were observed at the same positions as in the sample obtained in Example 1, indicating that a single-phase Cu₂ZnSnS₄ (CZTS) semiconductor powder was obtained as in Example 1.

### Example 10

### Preparation of CZTS Semiconductor Powder Using Different Raw-Materials (6)

Preparation of Cu₂ZnSnS₄ (CZTS) semiconductor powder and XRD analysis were conducted in the same manner as in Example 1 to obtain an XRD chart shown in FIG. 11, except that zinc nitrate instead of zinc sulfate heptahydrate, copper nitrate instead of copper sulfate pentahydrate, and nitric acid instead of sulfuric acid were added so that the additive amounts could be identical to those in Example 1 in terms of each element of Zn and Cu and that the pH of the preparatory liquid could be equal to that in Example 1 (pH7.5). FIG. 11 also shows, for reference, the XRD chart obtained in Example 1. As apparent from FIG. 11, even when the raw-materials were replaced as mentioned above, peaks were observed at the same positions as in the sample obtained in Example 1, indicating that a single-phase Cu₂ZnSnS₄ (CZTS) semiconductor powder was obtained as in Example 1.

### Example 11

### Preparation of CZTS Semiconductor Powder Using Different Raw-Materials (7)

Preparation of Cu₂ZnSnS₄ (CZTS) semiconductor powder and XRD analysis were conducted in the same manner as in Example 1 to obtain an XRD chart shown in FIG. 11, except that tin chloride (divalent) instead of tin sulfate, zinc nitrate instead of zinc sulfate heptahydrate, copper nitrate instead of copper sulfate pentahydrate, and nitric acid instead of sulfuric acid were added so that the additive amounts could be identical to those in Example 1 in terms of each element of Sn, Zn and Cu and that the pH of the preparatory liquid could be equal to that in Example 1 (pH7.5). FIG. 11 also shows, for reference, the XRD chart obtained in Example 1. As apparent from FIG. 11, even when the raw-materials were replaced as mentioned above, peaks were observed at the same positions as in the sample obtained in Example 1, indicating that a single-phase Cu₂ZnSnS₄ (CZTS) semiconductor powder was obtained as in Example 1.

### Example 12

### Preparation of CZTS Semiconductor Powder Using Cation Mixed Aqueous Solution

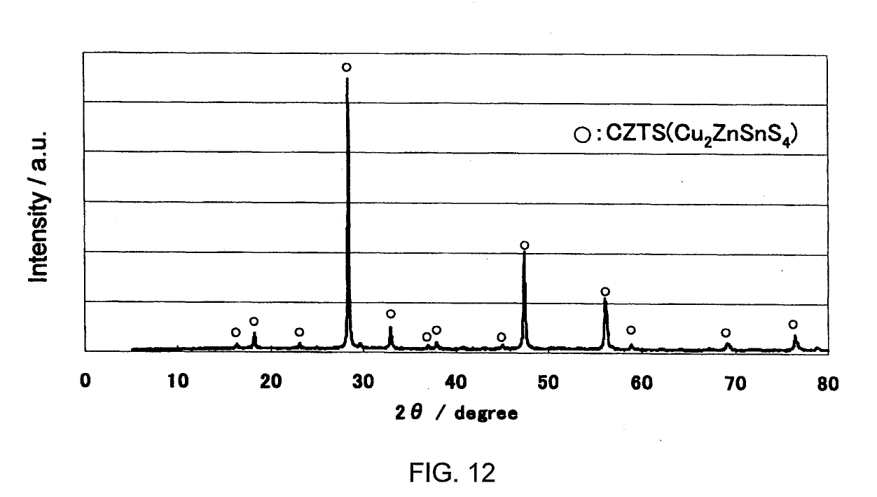

1.34 g of tin sulfate, 1.79 g of zinc sulfate heptahydrate and 3.12 g of copper sulfate pentahydrate were dissolved in 200 mL of water to prepare a mixed aqueous solution, which was then added into an ammonium sulfide aqueous solution to obtain a mixture liquid. A concentrated sulfuric acid was added to the mixture liquid to conduct neutralization to obtain a preparatory liquid of pH 7.5. The Cu:Zn:Sn:S ratio in the preparatory liquid was about 2:1:1:5. The mixture liquid was stirred for 1 hour with this pH being retained, followed by centrifugal filtration. The filtration residue was subjected to repulp washing with 200 mL of water, followed by suction filtration. The precipitates thus obtained were subjected to calcination (powder annealing) by retaining the precipitates for 2 hours under nitrogen atmosphere at 500° C. to obtain a Cu₂ZnSnS₄ (CZTS) semiconductor powder. The obtained powder was subjected to XRD analysis to obtain an XRD chart shown in FIG. 12. As apparent from FIG. 12, even when the raw-materials were added almost simultaneously, peaks were observed at the same positions as in the sample obtained in Example 1, indicating that a single-phase Cu₂ZnSnS₄. (CZTS) semiconductor powder was obtained as in Example 1.

### Example 13

### Preparation of CZTS Semiconductor Powder Using Different pH (1)

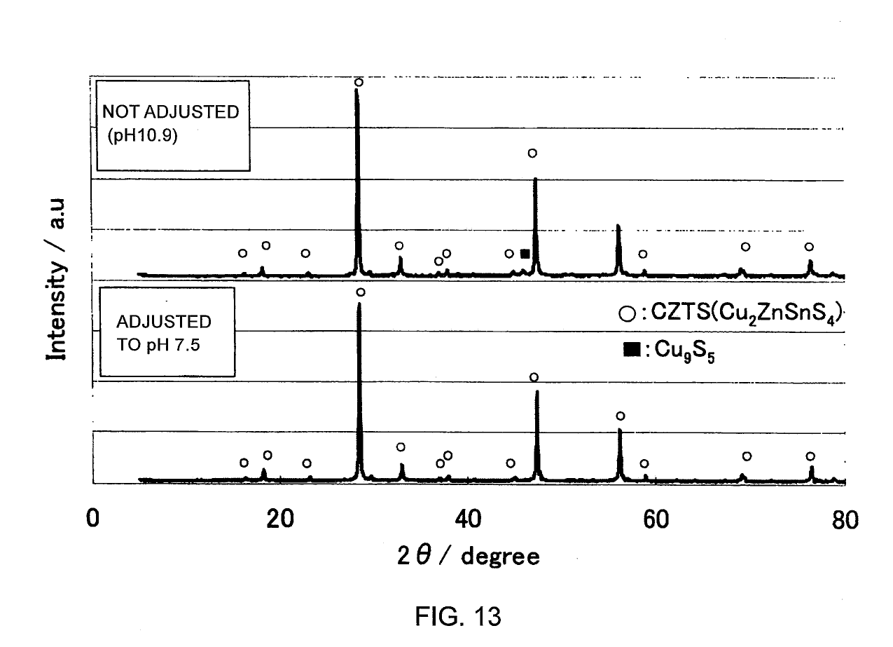

Preparation of Cu₂ZnSnS₄ (CZTS) semiconductor powder and XRD analysis were conducted in the same manner as in Example 1 to obtain an XRD chart shown in FIG. 13, except that the pH of the preparatory liquid was brought to 10.9 by not conducting the neutralization step of adding sulfuric acid. FIG. 13 also shows, for reference, the XRD chart of the sample obtained in Example 1 using the preparatory liquid of pH 7.5. As apparent from FIG. 13, a peak seemingly due to a by-product Cu₉S₅ was observed around a diffraction angle of 46°, when the pH of the preparatory liquid was 10.9. It is thus desirable to lower the pH of the preparatory liquid by adding an acid for neutralization as conducted in Example 1.

### Example 14

### Preparation of CZTS Semiconductor Powder Using Different pH (2)

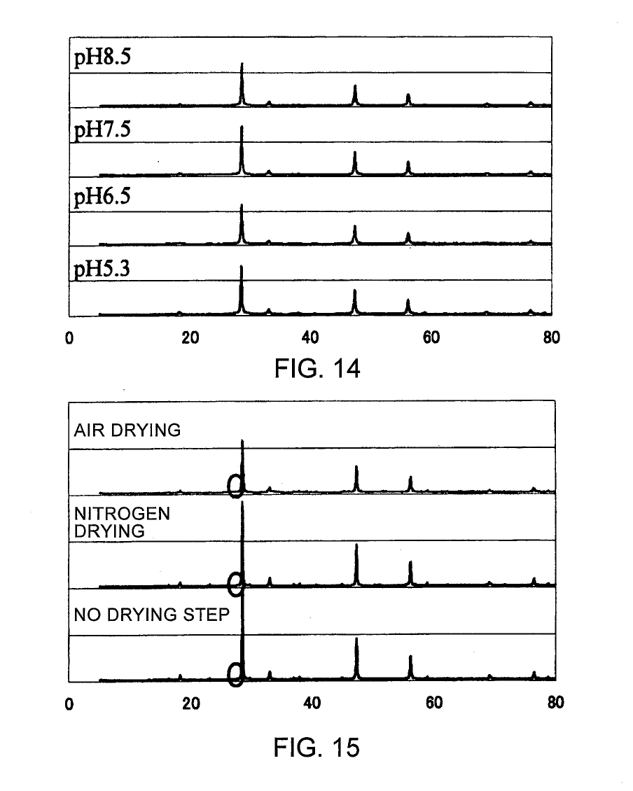

Preparation of Cu₂ZnSnS₄ (CZTS) semiconductor powder and XRD analysis were conducted in the same manner as in Example 1 to obtain XRD charts shown in FIG. 14, except that the pH of the preparatory liquid was brought to 5.3, 6.5 or 8.5 by varying the additive amount of sulfuric acid in the neutralization step. FIG. 14 also shows, for reference, the XRD chart of the sample obtained in Example 1 using the preparatory liquid of pH 7.5. As apparent from FIG. 14, in any of the samples resulting from the preparatory liquids of pH 5.3, 6.5 and 8.5, peaks were observed at the same positions as in the sample obtained in Example 1 using the preparatory liquid of pH 7.5, indicating that a single-phase Cu₂ZnSnS₄ (CZTS) semiconductor powder was obtained as in Example 1.

### Example 15

### Preparation of CZTS Semiconductor Powder Under Different Drying Condition

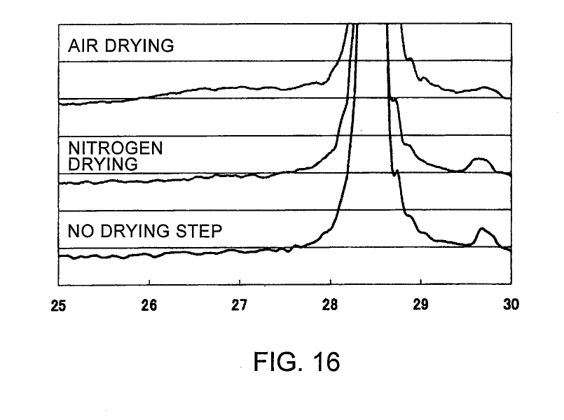

Preparation of Cu₂ZnSnS₄ (CZTS) semiconductor powder and XRD analysis were conducted in the same manner as in Example 1 to obtain XRD charts shown in FIGS. 15 and 16, except that the precipitates obtained by the natural filtration after the repulp washing was dried under nitrogen atmosphere or air atmosphere, prior to the powder annealing. FIG. 16 is an enlarged chart showing the circled portions in FIG. 15. FIGS. 15 and 16 also show, for reference, the XRD chart obtained without the drying step in Example 1. As apparent from FIG. 15, approximately similar peak behaviors were observed over the entire diffraction angles regardless of the drying conditions. It was, however, observed from the enlarged chart of FIG. 16 that the sample prepared through the drying step under air atmosphere exhibited a peak behavior seemingly due to tin oxide as a by-product between diffraction angles 25° and 28°, which was slightly different from the peak behavior of the sample prepared without the drying step or the sample prepared through the drying step under nitrogen atmosphere. From these results, it is understood that no drying step or, in the alternative, drying step under an atmosphere containing as less oxygen as possible is effective for obtaining a single-phase Cu₂ZnSnS₄ (CZTS) semiconductor powder of higher grade.

### Example 16

### Preparation of Cu₂CoSnS₄ Semiconductor Powder

40 mL of a tin sulfate aqueous solution containing 1.34 g of tin sulfate dissolved therein was added to 200 mL of 1 mass % ammonium sulfide aqueous solution, followed by stirring for 10 minutes. To the mixture liquid thus obtained, 40 mL of a cobalt nitrate aqueous solution containing 1.82 g of cobalt nitrate hexahydrate dissolved therein was added, followed by stirring for 10 minutes. Further, 120 mL of a copper sulfate aqueous solution containing 3.12 g of copper sulfate pentahydrate dissolved therein was added to the mixture liquid to provide a mixture liquid of pH 11.2. A concentrated sulfuric acid was added to this mixture liquid for neutralization to obtain a preparatory liquid of pH 7.5. The Cu:Co:Sn:S ratio in the preparatory liquid was about 2:1:1:5. The mixture liquid was stirred for 1 hour with this pH being retained, followed by centrifugal filtration. The filtration residue was subjected to repulp washing with 200 mL of water, followed by suction filtration. The precipitates thus obtained were subjected to calcination (powder annealing) by retaining the precipitates at 500° C. for 2 hours under nitrogen atmosphere to obtain a Cu₂CoSnS₄ (CCTS) semiconductor powder.

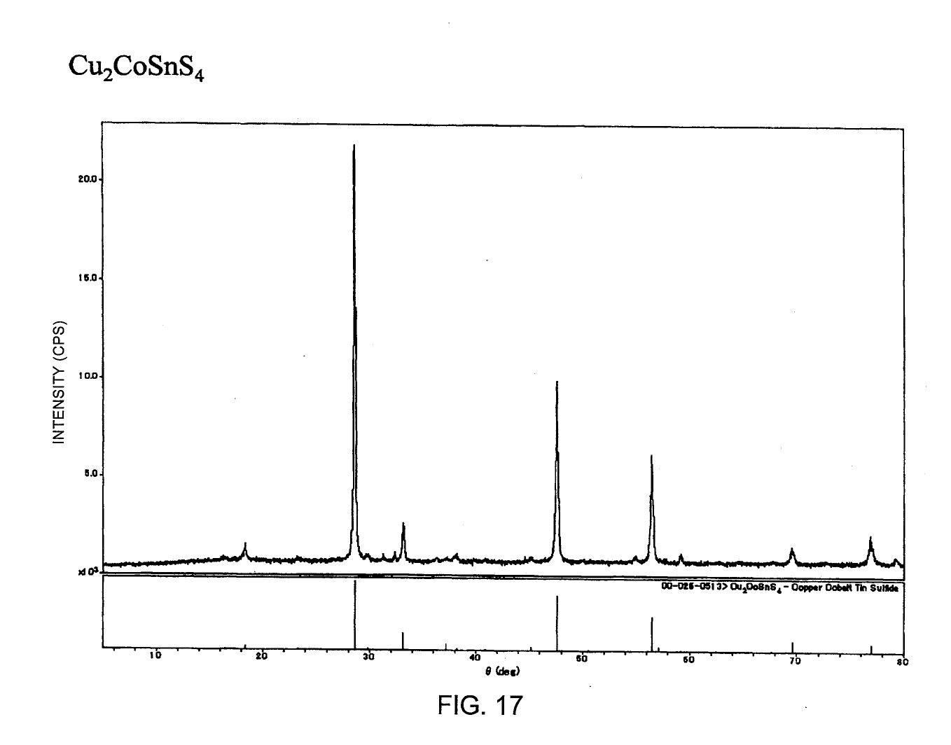

This semiconductor powder was subjected to XRD analysis by an X-ray powder diffractometer (XRD) (RINT-TTR III, Rigaku Corporation) to obtain an XRD chart shown in FIG. 17. By comparing the obtained XRD chart with the Cu₂CoSnS₄ single crystal chart in the JCPDS card (not shown), it was confirmed that the positions of the peaks in the both charts are identical to each other, meaning that the obtained semiconductor powder was a single-phase Cu₂CoSnS₄ semiconductor powder. While the height ratio of the second peak (the second highest peak) to the main peak (the highest peak) in the JCPDS card was calculated to be 0.8 (=80/100), the height ratio of the second peak to the main peak in the XRD chart obtained in this Example was calculated to be 0.45. It is therefore recognized that the height ratio of the second peak to the main peak of the Cu₂CoSnS₄ single-crystal powder obtained by wet synthesis tends to be lower than that in the JCPDS card.

### Example 17

### Preparation of Cu₂FeSnS₄ Semiconductor Powder

40 mL of a tin sulfate aqueous solution containing 1.34 g of tin sulfate dissolved therein was added to 200 mL of 1 mass % ammonium sulfide aqueous solution, followed by stirring for 10 minutes. To the mixture liquid thus obtained, 40 mL of an iron nitrate aqueous solution containing 2.525 g of iron nitrate nonahydrate dissolved therein was added, followed by stirring for 10 minutes. Further, 120 mL of a copper sulfate aqueous solution containing 3.12 g of copper sulfate pentahydrate dissolved therein was added to the mixture liquid to provide a mixture liquid of pH 11.2. A concentrated sulfuric acid was added to this mixture liquid for neutralization to obtain a preparatory liquid of pH 7.5. The Cu:Fe:Sn:S ratio in the preparatory liquid was about 2:1:1:5. The mixture liquid was stirred for 1 hour with this pH being retained, followed by centrifugal filtration. The filtration residue was subjected to repulp washing with 200 mL of water, followed by suction filtration. The precipitates thus obtained were subjected to calcination (powder annealing) by retaining the precipitates at 500° C. for 2 hours under nitrogen atmosphere to obtain a Cu₂FeSnS₄ (CITS) semiconductor powder.

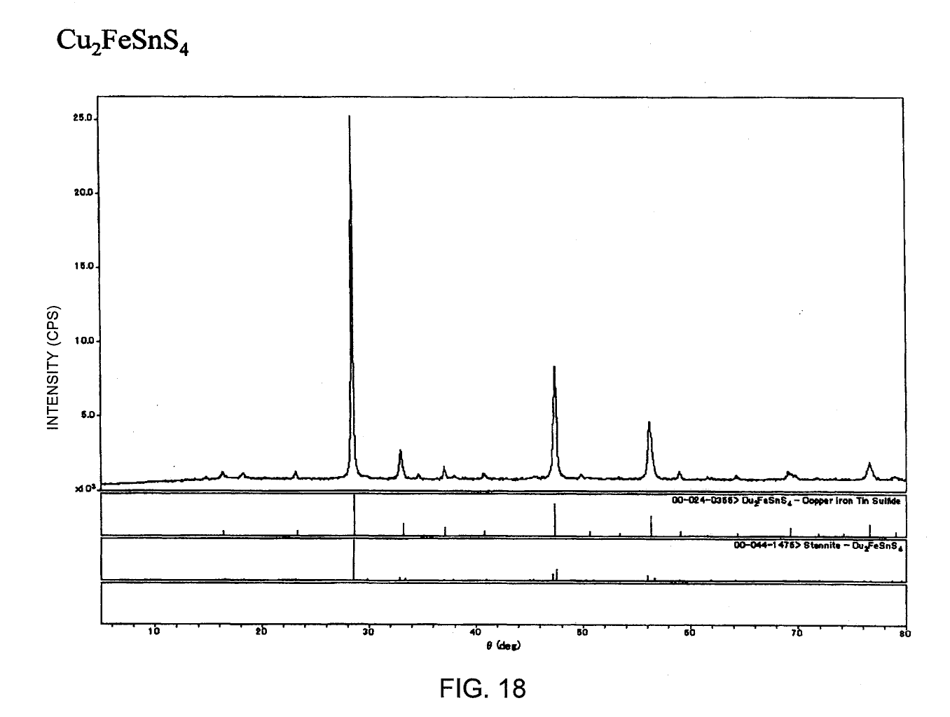

This semiconductor powder was subjected to XRD analysis by an X-ray powder diffractometer (XRD) (RINT-TTR III, Rigaku Corporation) to obtain an XRD chart shown in FIG. 18. By comparing the obtained XRD chart with the Cu₂FeSnS₄ single crystal chart in the JCPDS card (not shown), it was confirmed that the positions of the peaks in the both charts are identical to each other, meaning that the obtained semiconductor powder was a single-phase Cu₂FeSnS₄ semiconductor powder. While the height ratio of the second peak (the second highest peak) to the main peak (the highest peak) in the JCPDS card was calculated to be 0.8 (=80/100), the height ratio of the second peak to the main peak in the XRD chart obtained in this Example was calculated to be 0.32. It is therefore recognized that the height ratio of the second peak to the main peak of the Cu₂FeSnS₄ single-crystal powder obtained by wet synthesis tends to be lower than that in the JCPDS card.

### Example 18

### Preparation of Cu₂MnSnS₄ Semiconductor Powder

40 mL of a tin sulfate aqueous solution containing 1.34 g of tin sulfate dissolved therein was added to 200 mL of 1 mass % ammonium sulfide aqueous solution, followed by stirring for 10 minutes. To the mixture liquid thus obtained, 40 mL of an iron nitrate aqueous solution containing 1.81 g of manganese nitrate hexahydrate dissolved therein was added, followed by stirring for 10 minutes. Further, 120 mL of a copper sulfate aqueous solution containing 3.12 g of copper sulfate pentahydrate dissolved therein was added to the mixture liquid to provide a mixture liquid of pH 11.2. A concentrated sulfuric acid was added to this mixture liquid for neutralization to obtain a preparatory liquid of pH 7.5. The Cu:Mn:Sn:S ratio in the preparatory liquid was about 2:1:1:5. The mixture liquid was stirred for 1 hour with this pH being retained, followed by centrifugal filtration. The filtration residue was subjected to repulp washing with 200 mL of water, followed by suction filtration. The precipitates thus obtained were subjected to calcination (powder annealing) by retaining the precipitates at 500° C. for 2 hours under nitrogen atmosphere to obtain a Cu₂MnSnS₄ (CMTS) semiconductor powder.

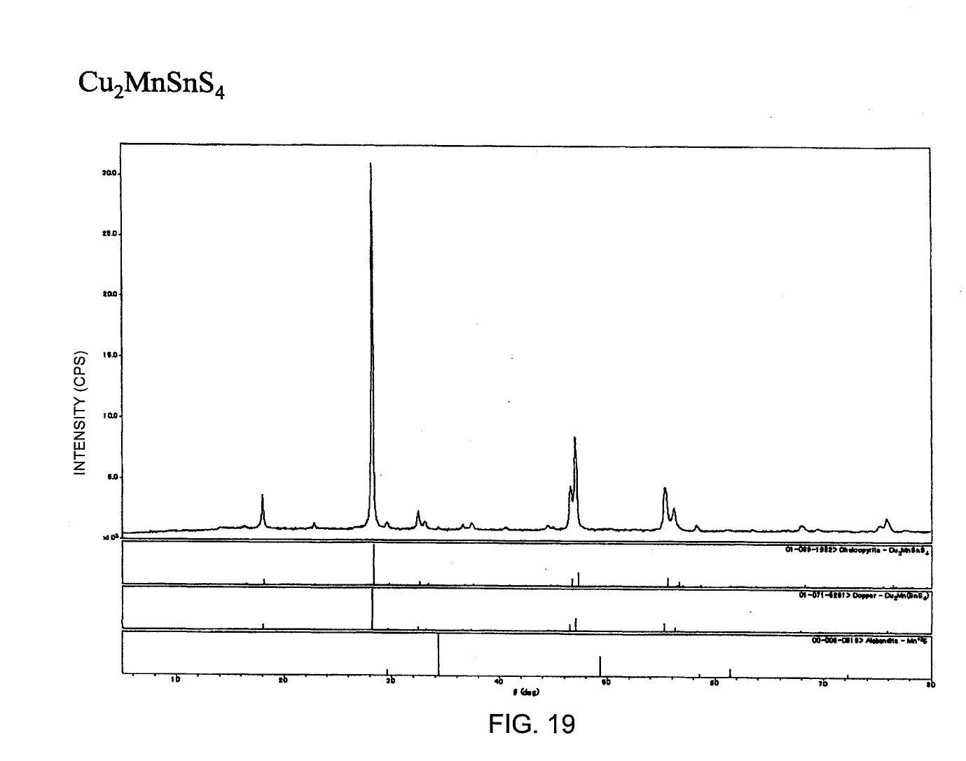

This semiconductor powder was subjected to XRD analysis by an X-ray powder diffractometer (XRD) (RINT-TTR III, Rigaku Corporation) to obtain an XRD chart shown in FIG. 19. By comparing the obtained XRD chart with the Cu₂MnSnS₄ single crystal chart in the JCPDS card (not shown), it was confirmed that the positions of the peaks in the both charts are identical to each other, meaning that the obtained semiconductor powder was a single-phase Cu₂MnSnS₄ semiconductor powder. While the height ratio of the second peak (the second highest peak) to the main peak (the highest peak) in the JCPDS card was calculated to be 0.38 (=38/100), the height ratio of the second peak to the main peak in the XRD chart obtained in this Example was calculated to be 0.28. It is therefore recognized that the height ratio of the second peak to the main peak of the Cu₂MnSnS₄ single-crystal powder obtained by wet synthesis tends to be lower than that in the JCPDS card.

### Example 19

### Measurement of Seebeck Coefficients on Various Powders

Powders having various compositions shown in Table 1 were prepared. The Seebeck coefficients of the prepared powders were measured in the same manner as in Example 1, except that the thicknesses of the pellets and the temperatures of the higher temperature parts and the lower temperature parts were set to the values shown in Table 1.

TABLE 1

| | | Higher | Lower | | | |
|---|---|---|---|---|---|---|
| | | Temperature | Temperature | Electromotive | | Seebeck |
| Semiconductor | Thickness t | Part Th | Part Tl | Force ΔV | Resistance R | Coefficient Z |
| Composition | (mm) | (° C.) | (° C.) | (mV) | (Ω) | (μV/° C.) |
| Cu₂CoSnS₄ | 5.65 | 31.48 | 13.72 | 2.285 | 90 | 129 |
| Cu₂NiSnS₄ | 7.33 | 33.18 | 13.90 | 1.971 | 30 | 102 |
| Cu₂FeSnS₄(1) | 6.81 | 34.54 | 14.53 | 3.105 | 60 | 155 |
| Cu₂FeSnS₄(2) | 7.20 | 35.66 | 15.14 | 3.181 | 60 | 155 |
| Cu₂(Fe_{0.2}Zn_{0.8})SnS₄(1) | 6.18 | 36.09 | 15.49 | 3.710 | 10000 | 180 |
| Cu₂(Fe_{0.2}Zn_{0.8})SnS₄(2) | 6.07 | 36.40 | 15.80 | 3.704 | 9000 | 182 |
| Cu₂MnSnS₄(1) | 6.58 | 35.33 | 15.03 | 1.831 | 150 | 90 |
| Cu₂MnSnS₄(2) | 6.15 | 36.25 | 14.99 | 1.900 | 130 | 89 |

Since the obtained values of Seebeck Coefficient Z were all positive values, it was confirmed that the powders having the compositions shown in Table 1 were all p-type semiconductors.

1. A semiconductor powder composed of Cu-M-Sn—S in a single phase wherein M is at least one selected from the group consisting of Zn, Co, Ni, Fe and Mn, the powder being obtained by wet synthesis.

2. The semiconductor powder according to claim 1, having a composition of Cu₂MSnSₓ, wherein x is 3.5 to 4.5.

3. The semiconductor powder according to claim 1, having a composition of Cu₂ZnSnS₄.

4. The semiconductor powder according to any one of claims 1 to 3, wherein each particle constituting the semiconductor powder has a particle size in the range of 0.10 to 1000 μm.

5. A method for producing a semiconductor powder composed of Cu-M-Sn—S in a single phase, wherein M is at least one selected from the group consisting of Zn, Co, Ni, Fe and Mn, the method comprising the steps of:
providing an aqueous solution of a sulfide selected from the group consisting of ammonium sulfide, ammonium polysulfide, sodium sulfide, thiourea and thioacetamide;
adding Cu, M and Sn and an inorganic acid into the aqueous solution separately or simultaneously, wherein the Cu, M and Sn are in the form of inorganic acid salt or aqueous solution thereof, to provide a mixture liquid having a pH of 4 to 9;
agitating the mixture liquid to form a precipitate;
filtrating the precipitate through solid-liquid separation;
calcinating the filtrated precipitate under inert gas atmosphere or under coexistence of a sulfur-containing compound except for sulfur oxides, to obtain the semiconductor powder.

6. The method according to claim 5, wherein the amount of the sulfide aqueous solution is chosen so as to supply sulfur in a sulfur proportion higher than a sulfur proportion of a stoichiometric composition of a semiconductor powder to be obtained.

7. The method according to claim 5 or 6, wherein the inorganic acid salt is at least one selected from the group consisting of sulfates, nitrates, acetates and chlorides, and wherein the inorganic acid is at least one selected from the group consisting of sulfuric acid, nitric acid, acetic acid and hydrochloric acid.

8. The method according to any one of claims 5 to 7, further comprising, prior to the calcination, the step of drying the filtered precipitate under inert gas atmosphere or under coexistence with a sulfur-containing compound other than sulfur oxides.

9. A dispersion liquid comprising precursor particles for a semiconductor powder dispersed in a solvent, wherein the semiconductor particles are composed of Cu-M-Sn—S, wherein M is at least one selected from the group consisting of Zn, Co, Ni, Fe and Mn, and wherein the precursor particles are obtained by wet synthesis.

10. The dispersion liquid according to claim 9, which is obtained from the precipitate formation step according to claim 5.

11. A semiconductor product which is produced by using the semiconductor powder according to any one of claims 1 to 4 or the dispersion liquid according to claim 9 or 10, wherein the semiconductor product is selected from the group consisting of pellets for vapor deposition, sputtering targets and semiconductor thin films.
